(19) United States
(12) Patent Application Publication
(10) Pub. No.: US 2026/0270966 A1
(43) Pub. Date: Sep. 10, 2026

(54) DATA TRANSMISSION METHOD AND APPARATUS, AND COMPUTER READABLE STORAGE MEDIUM

(71) Applicant: ZTE CORPORATION, Shenzhen, Guangdong (CN)

(72) Inventors: Yu XIN, Shenzhen (CN); Tong BAO, Shenzhen (CN); Jian HUA, Shenzhen (CN); Jin XU, Shenzhen (CN); Guanghui YU, Shenzhen (CN); Liujun HU, Shenzhen (CN)

(21) Appl. No.: 19/165,257

(22) PCT Filed: Jan. 4, 2024
(86) PCT No.: PCT/CN2024/070654

§ 371 Date: Sep. 15, 2025

(30) Foreign Application Priority Data
Apr. 3, 2023 (CN) 202310369438.6

(51) Int. Cl. H04W 72/0453; H04L 27/26; H04W 72/231; H04W 76/20

(52) U.S. Cl. CPC H04W 72/0453; H04L 27/2605; H04L 27/2634; H04W 72/231; H04W 76/20

(57) ABSTRACT

Provided are a data transmission method and apparatus, and a computer readable storage medium. The method includes: configuring a frequency domain bandwidth; where the frequency domain bandwidth is divided into a plurality of sub-bands, the plurality of sub-bands include a downlink sub-band and a dynamic sub-band; the dynamic sub-band is used for transmitting downlink data or uplink data; and transmitting the downlink data or the uplink data on the plurality of sub-bands included in the frequency domain bandwidth.

### CROSS-REFERENCE TO RELATED APPLICATION(S)

This application is a national phase entry under 35 USC 371 of International Patent Application No. PCT/CN2024/070654 filed on Jan. 4, 2024, the International Patent Application is filed based on Chinese Patent Application No. 202310369438.6, filed on Apr. 3, 2023, and claims priority to the Chinese Patent Application, the entire contents of the International Patent Application and the Chinese Patent Application are incorporated herein by reference.

### TECHNICAL FIELD

The present disclosure relates to the field of communication technologies, and in particular, to a data transmission method and apparatus, and a computer readable storage medium.

### BACKGROUND

In the field of communication technologies, communication between a base station and a user equipment is generally based on a frequency division duplexing mode. The frequency division duplexing refers that uplink data and/or downlink data is transmitted between the user equipment and the base station on different frequency bands.

### SUMMARY

In an aspect, the embodiments of the present disclosure provide a data transmission method. The data transmission method includes: configuring a frequency domain bandwidth; where the frequency domain bandwidth is divided into a plurality of sub-bands, and the plurality of sub-bands include a downlink sub-band and a dynamic sub-band; and the dynamic sub-band is used to transmit downlink data or uplink data;
transmitting the downlink data or the uplink data on the plurality of sub-bands included in the frequency domain bandwidth.

In another aspect, the embodiments of the present disclosure provide a data transmission apparatus. The data transmission apparatus includes: an acquiring module and a transmitting module. The acquiring module is configured to acquire a frequency domain bandwidth; where the frequency domain bandwidth is divided into a plurality of sub-bands, and the plurality of sub-bands include a downlink sub-band and a dynamic sub-band; the dynamic sub-band is used to transmit downlink data or uplink data; and the transmitting module is configured to transmit the downlink data or the uplink data on the plurality of sub-bands included in the frequency domain bandwidth.

In some embodiments, the frequency domain bandwidth is divided into N sub-bands, one of the N sub-bands is configured as a downlink sub-band; there are at least N-2 dynamic sub-bands among the N-1 sub-bands of the N sub-bands and except the downlink sub-band, and N is an integer greater than or equal to 2.

In some embodiments, the dynamic sub-band is configured to transmit the uplink data or downlink data based on control information.

In some embodiments, the control information is transmitted through the downlink sub-band.

In some embodiments, the control information is carried in a radio resource control (RRC) signaling or downlink control information (DCI).

In some embodiments, the N-1 sub-bands include an uplink sub-band and N-2 dynamic sub-bands; or, the N-1 sub-bands include N-1 dynamic sub-bands; or, the N-1 sub-bands include a downlink sub-band and N-2 dynamic sub-bands.

In some embodiments, N is an odd number, and the downlink sub-band is a middle sub-band among the N sub-bands; N is an even number, and the downlink sub-band is one of the two middle sub-bands among the N sub-bands.

In some embodiments, subcarrier spacings of the N sub-bands are the same, or, in a case where there are a plurality of dynamic sub-bands, subcarrier spacings of at least two of the plurality of dynamic sub-bands are different.

In some embodiments, a bandwidth of at least one of sub-bands of two ends of the N sub-bands is less than a bandwidth of a middle sub-band among the N sub-bands.

In some embodiments, a number of subcarriers of the N-2 middle sub-bands among the N sub-bands is 2 to a power of i (2\hat{ }i), and i is a positive integer.

In some embodiments, the transmitting module is configured to, in a case where there are M sub-bands for transmitting the downlink data among the N sub-bands, perform an inverse Fourier transform on the downlink data on each sub-band among the M sub-bands, to obtain M groups of first data sequences; M is a positive integer; add an all-zero data sequence to other sub-bands except the M sub-bands among the N sub-bands to obtain N-M groups of second data sequences; a length of the second data sequence is identical to a length of the first data sequence; perform the inverse Fourier transform on the M groups of first data sequences and the N-M groups of second data sequences, to obtain a time-domain transmission data sequence; and transmit the time-domain transmission data sequence.

In some embodiments, the M sub-bands include a downlink sub-band and a dynamic sub-band for transmitting the downlink data.

In some embodiments, the inverse Fourier transform performed on the downlink data on each sub-band among the M sub-bands is an oversampled inverse Fourier transform.

In some embodiments, positions of zero-frequency positions in frequency domain where the oversampled inverse Fourier transform is performed on the downlink data on respective sub-bands among the M sub-bands are different.

In some embodiments, a zero-frequency position where the oversampled inverse Fourier transform is performed on downlink data on a sub-band among the M sub-bands is within a frequency range of a bandwidth of a sub-band.

In some embodiments, a zero-frequency position where the oversampled inverse Fourier transform is performed on downlink data on a sub-band among the M sub-bands is within a frequency range of a sub-carrier of the sub-band.

In some embodiments, the transmitting module is configured to acquire N groups of third data sequences from a data matrix by columns; where the data matrix includes: the M groups of first data sequences and the N-M groups of second data sequences arranged by rows based on an order of the N sub-bands; and perform the oversampled inverse Fourier transform on the N groups of third data sequences, to obtain the time-domain transmission data sequence.

In some embodiments, each data sequence among the M groups of first data sequences includes a cyclic prefix (CP).

In some embodiments, the transmitting module is configured to perform the oversampled inverse Fourier transform on the N groups of third data sequences, to obtain N groups of fourth data sequences; and perform a windowing operation on the N groups of fourth data sequences, to obtain the time-domain transmission data sequence.

In some embodiments, the transmitting module is configured to perform the oversampled inverse Fourier transform on the N groups of third data sequences, to obtain N groups of fourth data sequences; and perform a preset processing on the N groups of fourth data sequences respectively and perform an adding, to obtain the time-domain transmission data sequence; where the preset processing includes: downsampling, filtering and upsampling.

In some embodiments, the transmitting module is configured to perform a filtering operation or a windowing operation on the time-domain transmission data sequence, and then perform a digital-to-analog converter (DAC) processing and a radio frequency (RF) processing before transmission.

In some embodiments, a number of points for the oversampled inverse Fourier transform performed on the downlink data on each sub-band is less than a total number of subcarriers of the plurality of sub-bands. The 2-times oversampled inverse Fourier transform is performed on the N-2 middle sub-bands among the N sub-bands.

In some embodiments, a number of points for the oversampled inverse Fourier transform performed on the N groups of third data sequences is greater than a number of the plurality of sub-bands.

In yet another aspect, the embodiments of the present disclosure provide a communication apparatus. The communication apparatus includes: a memory and a processor; the memory and the processor are coupled with each other; the memory is configured to store a computer program; the processor, when executing the computer program, implements the data transmission method as described in the above aspect and embodiments thereof.

In yet another aspect, the embodiments of the present disclosure provide a computer readable storage medium. The computer readable storage medium has stored computer program instructions thereon, and the computer program instructions, when executed by a processor, implement the data transmission method as described in the above aspect and embodiments thereof.

In yet another aspect, the embodiments of the present disclosure provide a computer program product. The computer program product includes computer program instructions, and the computer program instructions, when executed by a processor, implement the data transmission method as described in the above aspect and embodiments thereof.

### BRIEF DESCRIPTION OF THE DRAWINGS

In order to illustrate technical solutions in the present disclosure more clearly, the drawings to be used in some embodiments of the present disclosure will be introduced briefly. Obviously, the drawings to be described below are merely drawings of some embodiments of the present disclosure, and those ordinary skilled in the art may also obtain other drawings according to these drawings.

FIG. 1 is a schematic diagram of an architecture of a communication network according to some embodiments.

FIG. 2 is a schematic flowchart of a data transmission method according to some embodiments.

FIG. 3 is a schematic flowchart of another data transmission method according to some embodiments.

FIG. 4 is a schematic flowchart of yet another data transmission method according to some embodiments.

FIG. 5 is a schematic diagram of a division of a frequency domain bandwidth according to some embodiments.

FIG. 6 is a schematic diagram of a division of another frequency domain bandwidth according to some embodiments.

FIG. 7 is a schematic diagram of a division of yet another frequency domain bandwidth according to some embodiments.

FIG. 8 is a schematic diagram of a process of a data transmission according to some embodiments.

FIG. 9 is a schematic diagram of a process of another data transmission according to some embodiments.

FIG. 10 is a schematic diagram of a process of yet another data transmission according to some embodiments.

FIG. 11 is a schematic diagram of a process of yet another data transmission according to some embodiments.

FIG. 12 is a schematic diagram of a process of yet another data transmission according to some embodiments.

FIG. 13 is a schematic diagram of a process of yet another data transmission according to some embodiments.

FIG. 14 is a schematic diagram of a data transmission apparatus according to some embodiments.

FIG. 15 is a schematic diagram of a communication apparatus according to some embodiments.

### DETAILED DESCRIPTION

In order to enable those skilled in the art to better understand technical solutions of the embodiments of the present disclosure, the technical solutions in the present disclosure will be described below clearly and completely with reference to the drawings. Obviously, the described embodiments are merely some but not all of the embodiments of the present disclosure. All other embodiments obtained based on the embodiments of the present disclosure by the ordinary skilled in the art without paying any creative effort, shall be included in the protection scope of the present disclosure.

It should be noted that, in the present disclosure, the expressions such as “exemplary/exemplarily” or “for example” are used to present an example, illustration, or explanation. Any embodiment or design scheme described with “exemplary/exemplarily” or “for example” in the present disclosure should not be construed as preferred or advantageous over other embodiments or design schemes. Rather, the usage of the expressions, such as “exemplary/exemplarily” or “for example”, etc., is intended to present relevant concepts in a detailed manner.

Hereinafter, the terms “first”, “second”, etc., are used for descriptive purposes only, but are not to be construed as indicating or implying relative importance or implicitly indicating a number of indicated technical features. Thus, features defined with “first” or “second”, etc., may explicitly or implicitly include one or more of the features.

In the description of the present disclosure, unless otherwise specified, the symbol “/” means “or”, and for example, A/B may represent A or B. Herein, “and/or” is only used to describe an associated relationship between associated objects, representing that there may be three relationships, and for example, A and/or B may mean: only A, only B, and both A and B. Additionally, “at least one” means one or more, and “multiple/plurality of” means two or more.

In order to facilitate understanding of the technical solutions of the present disclosure, the terms involved in the present disclosure are briefly introduced below.
1. Frequency domain bandwidth: refers to a bandwidth of a transmission resource used to transmit a signal in frequency domain, that is, a frequency range occupied by the signal, usually represented by Hertz (Hz).
2. Sub-band: a signal component within different frequency ranges divided by the frequency domain bandwidth. A frequency domain bandwidth may be divided into a plurality of sub-bands. A sub-band may include one or more subcarriers and different sub-bands correspond to different frequency ranges.
3. Uplink and downlink: refer to a transmission direction of the signal or data. Uplink refers to the transmission direction from a user equipment to a base station, and downlink refers to a transmission direction from the base station to the user equipment. The data transmitted in uplink may be referred to as uplink data, and the data transmitted in downlink may be referred to as downlink data.
4. Inverse Fourier transform (Inverse Fourier Transform, IFT)/inverse fast Fourier transform (Inverse Fast Fourier Transform, IFFT): in the field of signal processing, it is a method used to convert frequency domain data into time domain data.

In some technologies, frequency division duplexing is generally used for communication. Frequency division duplexing cannot flexibly allocate frequency domain resources, resulting in low utilization of frequency domain resources. Based on this, the embodiments of the present disclosure provide a data transmission method, in which a frequency domain bandwidth acquired in the method is divided into a plurality of sub-bands, where the plurality of sub-bands include a downlink sub-band and a dynamic sub-band. The dynamic sub-band is used to transmit downlink data or transmit uplink data. Therefore, when data is transmitted on the plurality of sub-bands, transmission resources for uplink data and downlink data may be flexibly allocated on the dynamic sub-band, thereby improving the utilization of frequency domain resources.

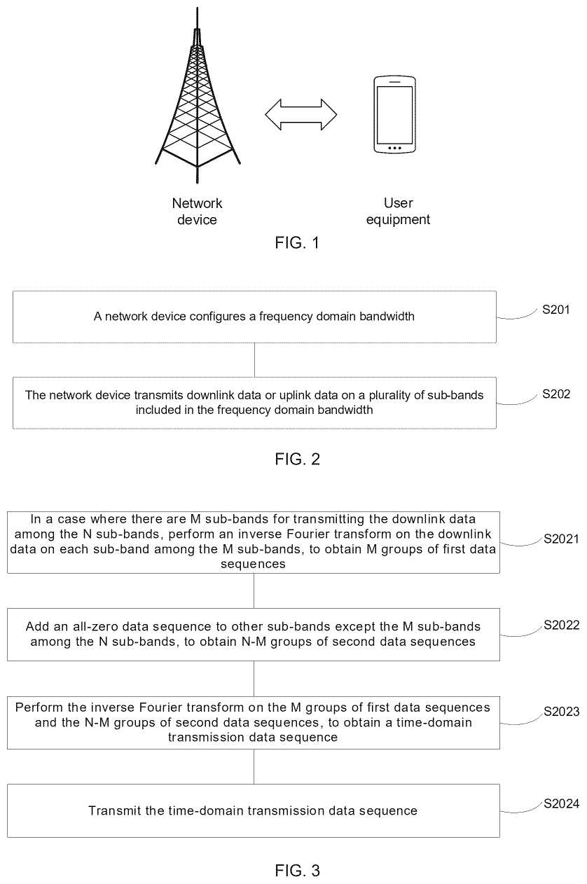

FIG. 1 is a structural schematic diagram of a communication system according to some embodiments. As shown in FIG. 1, the communication system includes a network device and a user equipment (UE). The network device and the UE may be connected by a wired network or a wireless network. The wired network or wireless network may include a router, a switch, or other devices that facilitate communication between the network devices and the UE, which is not limited to the embodiments of the present disclosure.

In some embodiments, the network device is used to provide radio access services to the UE. For example, a network device provides a service coverage area (also referred to as a cell). A UE entering the area may communicate with the network device by a wireless signal, to receive a radio access service provided by the network device. In addition, the service coverage area of the network device may also be classified into a near-field area and a far-field area. The UE may be located within the near-field range and the UE may also be located within the far-field range.

In some embodiments, the network device may be an evolutional base station (evolution nodeB, eNB), a next generation base station (generation nodeB, gNB), a transmission receive point (TRP), a transmission point (TP), and some other access nodes. According to a size of the provided service coverage area, the base station may be classified into a macro base station for providing a macro cell (Macro cell), a micro base station for providing a pico cell (Pico cell) and a femto base station for providing a femto cell (Femto cell). With the continuous evolution of wireless communication technologies, other names for future network devices may also be adopted.

In some embodiments, the UE may be a device with a wireless transceiver function (e.g., a mobile phone device, a Pad device, a wearable device, a vehicle-mounted device, an augmented reality (AR)/virtual reality (VR) device, a notebook computer, an ultra-mobile personal computer (UMPC) device, a netbook device, a personal digital assistant (PDA), etc.). The embodiments of the present disclosure do not limit the types of user equipment.

It should be understood that, FIG. 1 is an exemplary structural diagram, and a number of devices included in the communication system shown in FIG. 1 is not limited thereto, and for example, the number of network devices is not limited thereto and the number of UEs is not limited thereto. Furthermore, in addition to the devices shown in FIG. 1, the communication system shown in FIG. 1 may also include other devices, which is not limited thereto.

FIG. 2 is a schematic flowchart of a data transmission method according to some embodiments. Exemplarily, the data transmission method provided by the present disclosure may be applied to the communication system shown in FIG. 1. In other words, the network device and UE in FIG. 1 may interactively perform the data transmission method. The data transmission method is introduced below by taking the network device in FIG. 1 as an execution entity.

As shown in FIG. 2, the data transmission method provided by the present disclosure may include the following contents, for example.

S201, a network device configures a frequency domain bandwidth.

The frequency domain bandwidth is divided into a plurality of sub-bands. The plurality of sub-bands include a downlink sub-band and a dynamic sub-band. The downlink sub-band is used for fixedly transmitting downlink data. The downlink sub-band may be alternatively described as a fixed downlink sub-band. The dynamic sub-band may be used to transmit downlink data or transmit uplink data, that is, the dynamic sub-band may be a downlink sub-band or an uplink sub-band. For the convenience of description, hereinafter, a dynamic sub-band for transmitting the downlink data is referred to as a dynamic downlink sub-band, and a dynamic sub-band for transmitting the uplink data is referred to as a dynamic uplink sub-band. A downlink sub-band for fixedly transmitting downlink data is referred to as a fixed downlink sub-band, and an uplink sub-band for fixedly transmitting the uplink data is referred to as a fixed uplink sub-band.

It should be noted that, the frequency domain bandwidth being divided into a plurality of sub-bands can more effectively distinguish frequency components of the signal. Since frequency ranges corresponding to different sub-bands are inconsistent, when the signal is transmitted on different sub-bands, the effect of the signal in different frequency ranges may be controlled more accurately. In addition, the division of the frequency domain bandwidth may be a default configuration or pre-specified by a protocol or configured by a base station, which is not limited to the present disclosure.

In some embodiments, the frequency domain bandwidth is divided into N sub-bands, one of the N sub-bands is configured as a downlink sub-band (or referred to as a fixed downlink sub-band); there are at least N-2 dynamic sub-bands among the N-1 sub-bands of the N sub-bands and except the downlink sub-band, and N is an integer greater than or equal to 2. For example, among the five divided sub-bands, a sub-band is a downlink sub-band, and at least three sub-bands are dynamic sub-bands.

In some embodiments, the N-1 sub-bands may include an uplink sub-band and N-2 dynamic sub-bands; or, the N-1 sub-bands may include N-1 dynamic sub-bands (i.e., all N-1 sub-bands are dynamic sub-bands); or, the N-1 sub-bands may include a downlink sub-band and N-2 dynamic sub-bands. The division cases may refer to those described in the following embodiments.

In some embodiments, the dynamic sub-band may be configured to transmit uplink data or transmit downlink data based on control information (i.e., the dynamic sub-band may be configured as an uplink sub-band or a downlink sub-band based on the control information).

In some embodiments, at least one dynamic sub-band is configured as an uplink sub-band.

The above control information may be transmitted through a fixed downlink sub-band among the N sub-bands. Exemplarily, the control information may be carried in an RRC signaling or DCI.

In some embodiments, when the network device is a UE, the UE may acquire the frequency domain bandwidth according to a pre-configuration, and the UE may also acquire the frequency domain bandwidth according to an indication of the base station. For example, the UE may receive a resource configuration indication from the base station, and the resource configuration indication is used to indicate the frequency domain bandwidth, and the UE acquires the frequency domain bandwidth according to the resource configuration indication.

In some embodiments, a bandwidth of at least one of the two end bands of the N sub-bands is less than a bandwidth of a middle sub-band of the N sub-bands.

In some embodiments, a number of subcarriers in the N-2 middle sub-bands among the N sub-bands is 2 to a power of i, and i is a positive integer.

S202, the network device transmits downlink data or uplink data on a plurality of sub-bands included in the frequency domain bandwidth.

The network device, after acquiring the frequency domain bandwidth divided into a plurality of sub-bands, may transmit the downlink data to a user equipment or receive the uplink data sent by the user equipment on the plurality of sub-bands included in the frequency band bandwidth, thereby implementing communication between the network device and the user equipment.

In some embodiments, as shown in FIG. 3, S202 is implemented as S2021 to S2024 as follows.

S2021, in a case where there are M sub-bands for transmitting the downlink data among the N sub-bands, perform an inverse Fourier transform on the downlink data on each sub-band among the M sub-bands, to obtain M groups of first data sequences. M is a positive integer.

S2022, add an all-zero data sequence to other sub-bands except the M sub-bands among the N sub-bands, to obtain N-M groups of second data sequences. A length of the second data sequence is identical to a length of the first data sequence.

S2023, perform an inverse Fourier transform on the M groups of first data sequences and the N-M groups of second data sequences, to obtain a time-domain transmission data sequence.

S2024, transmit the time-domain transmission data sequence.

There are M sub-bands for transmitting the downlink data among the N sub-bands divided by the frequency domain bandwidth. When the data transmission is performed, the base station performs the inverse Fourier transform on downlink data on each sub-band among the M sub-bands, to obtain M groups of first data sequences. In addition, the all-zero data sequence is added to other sub-bands (i.e., sub-bands for transmitting the uplink data) among the M sub-bands, to obtain N-M groups of second data sequences. A length of the second data sequence is identical to a length of the first data sequence.

Furthermore, the inverse Fourier transform is performed on the M groups of first data sequences and the N-M groups of second data sequences, to obtain a group of time-domain transmission data sequences, which then is transmitted. Exemplarily, the group of time-domain transmission data sequences is obtained by serially concatenating time-domain data generated by a plurality of inverse Fourier transforms and then performed a filtering operation.

In some embodiments, the M sub-bands include a downlink sub-band and a dynamic sub-band for transmitting the downlink data. That is, the M sub-bands for transmitting the downlink data include the aforementioned one downlink sub-band and other M-1 dynamic sub-bands configured to transmit the downlink data.

In some embodiments, the inverse Fourier transform performed on the downlink data on each sub-band among the M sub-bands is an oversampled inverse Fourier transform.

In some embodiments, positions of zero-frequency positions in frequency domain where the oversampled inverse Fourier transform is performed on the downlink data on respective sub-bands among the M sub-bands are different. A zero-frequency position where an oversampled inverse Fourier transform is performed on the downlink data on a sub-band among the M sub-bands is within a frequency range of a bandwidth of the sub-band. The zero-frequency position where an oversampled inverse Fourier transform is performed on the downlink data on a sub-band among the M sub-bands is within a frequency range of subcarriers of the sub-band.

The zero-frequency position represents a position of a frequency component representing an offset in the signal during the inverse Fourier transform process. Since the oversampled inverse Fourier transform is required to be performed on the downlink data of the M sub-bands respectively in the present embodiment, the set zero-frequency positions where the oversampled inverse Fourier transform is performed on the downlink data corresponding to different sub-bands are different, and are within frequency ranges of respective sub-bands, which guarantees the accuracy of signal reconstruction during the inverse Fourier transform process.

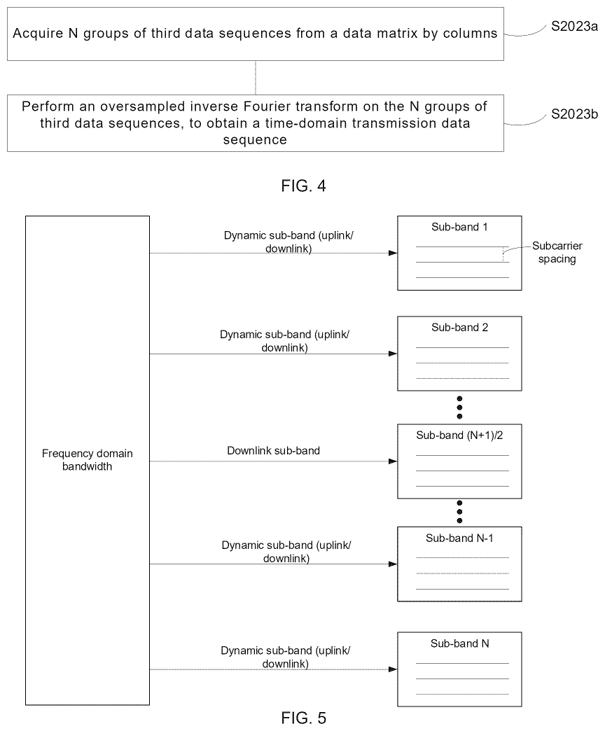

In some embodiments, as shown in FIG. 4, the above S2023 is implemented as S2023a to S2023b as follows.

S2023a, acquire N groups of third data sequences from a data matrix by columns.

The data matrix includes: the M groups of first data sequences and the N-M groups of second data sequences arranged by rows based on an order of the N sub-bands.

S2023b, perform an oversampled inverse Fourier transform on the N groups of third data sequences, to obtain a time-domain transmission data sequence.

It should be understood that, a number of groups of the M groups of first data sequences and the N-M groups of second data sequences corresponds to a number N of sub-bands. According to an arrangement order of the sub-bands, the M groups of first data sequences and the N-M groups of second data sequences are arranged by rows to obtain a data matrix, and then N groups of third data sequences are extracted from the data sequences by columns and the oversampled inverse Fourier transform is performed on the N groups of third data sequences, that is, to obtain the time-domain transmission data sequence.

In some embodiments, each data sequence among the M groups of first data sequences includes a cyclic prefix (CP). The cyclic prefix is used as a guard interval in the inverse Fourier transform process to eliminate interference between subcarriers and make signal reconstruction more accurate.

In some embodiments, the above S2023b may be implemented as Step a to Step b as follows.

Step a, perform the oversampled inverse Fourier transform on the N groups of third data sequences, to obtain N groups of fourth data sequences (also referred to as sub-symbols). Step b, perform a windowing operation on the N groups of fourth data sequences, to obtain the time-domain transmission data sequence. It should be noted that, the windowing operation may suppress harmonic leakage of the signal and improve the accuracy of the signal.

Exemplarily, the windowing operation may include: respectively performing a repeated sampling on respective fourth data sequences, multiplying each sampling point by a preset function, and then performing a misaligned overlapping addition, to obtain the time-domain transmission data sequence. The preset function includes any one of: a root raised cosine function, a raised cosine function, a rectangular function, an IOTA function.

In some other embodiments, the above S2023b may be implemented as Step c to Step d as follows.

Step c, perform the oversampled inverse Fourier transform on the N groups of third data sequences, to obtain N groups of fourth data sequences. Step d, add the N groups of fourth data sequences that a preset processing is performed respectively, to obtain the time-domain transmission data sequence. The preset processing includes downsampling, filtering and upsampling.

Exemplarily, operations of the preset processing performed on the fourth data sequences respectively include, for example: first performing downsampling on each fourth data sequence to form a plurality of groups of parallel data, then using a filter group to respectively perform a filtering operation on each group of parallel data among the plurality of groups of parallel data, and then adding and merging each group of parallel data among the plurality of groups of parallel data after the upsampling is performed, to obtain the time-domain transmission data sequence.

In some embodiments, the above S2024 may be implemented as: performing a filtering operation or a windowing operation on the time-domain transmission data sequence and then performing a digital to analog converter (DAC) processing and a radio frequency (RF) processing before transmission. The filtering operation mentioned here may be single-phase filtering or multi-phase filtering. The multi-phase filtering is to filter each group of sequences divided in the time-domain transmission data sequence. It should be noted that, the DAC processing and the RF processing are the processes of converting digital signals into analog signals and performing radio frequency modulation. The main purpose is to convert digital signals into analog signals suitable for transmission in the frequency domain bandwidth for reception by the user equipment.

In some embodiments, a number of points for the oversampled inverse Fourier transform of downlink data on each sub-band is less than a total number of subcarriers of the plurality of sub-bands; and a 2-times oversampled inverse Fourier transform is performed on N-2 middle sub-bands among the N sub-bands.

In some embodiments, a number of points of the oversampled inverse Fourier transform performed on the N groups of third data sequences is greater than a number of the plurality of sub-bands. It should be understood that, the number of points of the oversampled inverse Fourier transform determines the sampling rate and the accuracy of the signal. In the embodiments of the present disclosure, the number of points is limited within the above range, which may reduce the amount of computing and ensure data transmission efficiency while ensuring accuracy of the signal reconstruction.

Different cases of divisions of the frequency domain bandwidth are explained below in combination with the embodiments and drawings of the specification.

### Embodiment 1

The frequency domain bandwidth is divided into N sub-bands, one of the N sub-bands is configured as a downlink sub-band (or referred to as a fixed downlink sub-band); N-1 sub-bands except the downlink sub-band among the N sub-bands are configured as dynamic sub-bands. Further, N is an odd number, and the downlink sub-band is a middle sub-band among the N sub-bands.

By taking FIG. 5 as an example, FIG. 5 is a schematic diagram of the division of the frequency domain bandwidth according to some embodiments. In this embodiment, as shown in FIG. 5, the frequency domain bandwidth is divided into N sub-bands, and the N sub-bands are numbered as sub-band 1, sub-band 2, ..., sub-band N in an order from top to bottom, where N is an odd number. For example, the sub-band 1 is a sub-band with a smallest frequency position, and the sub-band N is a sub-band with a largest frequency position. It should be noted that, the directional terms such as “upper” and “lower” described here are explained with reference to the directions in the drawings and do not constitute a limitation.

Among the N sub-bands shown in FIG. 5, the middle sub-band (or a sub-band at a middle position in the frequency position) is a downlink sub-band (a fixed downlink sub-band), that is, a sub-band numbered (N+1)/2 is a downlink sub-band for transmitting downlink data. The other N-1 sub-bands are dynamic sub-bands, which may be configured to transmit uplink data or downlink data according to the control information transmitted through the downlink sub-band.

In this embodiment, subcarrier spacings of the N sub-bands are the same, or, in a case where there are a plurality of dynamic sub-bands, the subcarrier spacings of at least two of the plurality of dynamic sub-bands are different. For example, as shown in FIG. 5, the subcarrier spacings of the N sub-bands are the same.

### Embodiment 2

The frequency domain bandwidth is divided into N sub-bands, one of the N sub-bands is configured as a downlink sub-band (or referred to as a fixed downlink sub-band); N-1 sub-bands of the N sub-bands and except the downlink sub-band are configured as N-2 dynamic sub-bands and an uplink sub-band. Further, N is an even number, and the downlink sub-band is one of the two middle sub-bands among the N sub-bands.

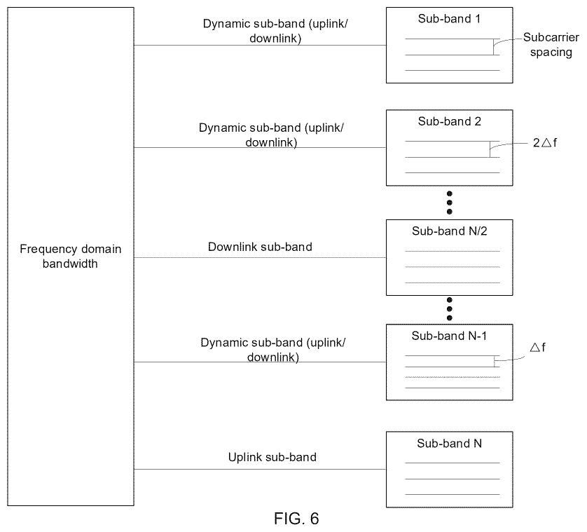

By taking FIG. 6 as an example, FIG. 6 is a schematic diagram of another division of the frequency domain bandwidth according to some embodiments. In this embodiment, as shown in FIG. 6, the frequency domain bandwidth is divided into N sub-bands, and the N sub-bands are numbered as sub-band 1, sub-band 2, ..., sub-band N in an order from top to bottom, where N is an even number.

The N sub-bands include a downlink sub-band, an uplink sub-band and N-2 dynamic sub-bands. For example, as shown in FIG. 6, the sub-band with a smaller number among the two sub-bands in the middle position is a downlink sub-band (i.e., numbered N/2). The sub-band with a largest frequency position (that is, the sub-band N is the uplink sub-band) is used for fixedly transmitting uplink data. That is, the base station may acquire data sent by the user equipment by the sub-band N. The other N-2 sub-bands are dynamic sub-bands, and may be configured to transmit uplink data or downlink data based on control information transmitted through the downlink sub-band numbered N/2.

In this embodiment, subcarrier spacings of the N sub-bands are the same, or, in a case where there are a plurality of dynamic sub-bands, the subcarrier spacings of at least two of the plurality of dynamic sub-bands are different. For example, as shown in FIG. 6, the subcarrier spacing of the dynamic sub-band numbered N-1 among the N sub-bands is different from the subcarrier spacings of other dynamic sub-bands. For example, the subcarrier spacing of the dynamic sub-band N-1 is Δf, and the subcarrier spacings of other dynamic sub-bands are all 2Δf.

### Embodiment 3

The frequency domain bandwidth is divided into N sub-bands, one of the N sub-bands is configured as a downlink sub-band (or referred to as a fixed downlink sub-band); N-1 sub-bands of the N sub-bands and except the downlink sub-band are configured as N-2 dynamic sub-bands and an uplink sub-band. A number of subcarriers in the N-2 middle sub-bands among the N sub-bands is 2 to a power of i, and i is a positive integer.

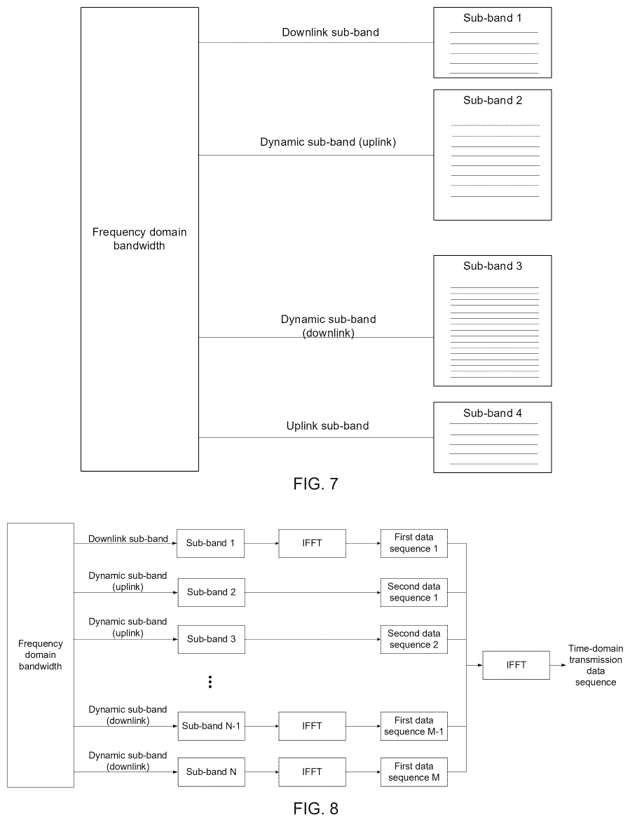

Taking FIG. 7 as an example, FIG. 7 is a schematic diagram of yet another division of the frequency domain bandwidth according to some embodiments. In this embodiment, as shown in FIG. 7, the frequency domain bandwidth is divided into 4 sub-bands, and the 4 sub-bands are respectively numbered as sub-band 1, sub-band 2, sub-band 3, and sub-band 4 in an order from top to bottom.

The sub-band 1 is a downlink sub-band, used to transmit the downlink data. The sub-band 4 is an uplink sub-band, used to transmit the uplink data. The sub-band 2 and sub-band 3 are dynamic sub-bands. In this embodiment, the sub-band 2 as a dynamic sub-band, is configured to transmit the uplink data, and the sub-band 3 as a dynamic sub-band, is configured to transmit the downlink data.

The sub-band 1 (downlink sub-band) includes 6 subcarriers, and the subcarrier spacing is 2Δf, so the bandwidth of sub-band 1 is 6×2Δf=12Δf.

The sub-band 2 (dynamic uplink sub-band) contains 8 (2 to a power of 3) subcarriers, and the subcarrier spacing is 2Δf, so the bandwidth of sub-band 2 is 2³×2Δf=16Δf.

The sub-band 3 (dynamic downlink sub-band) contains 16 (2 to a power of 4) subcarriers, and the subcarrier spacing is Δf, so the bandwidth of sub-band 3 is 2⁴×Δf=16Δf.

The sub-band 4 (uplink sub-band) contains 6 subcarriers, and the subcarrier spacing is 2Δf, so the bandwidth of sub-band 4 is 6×2Δf=12Δf.

In this embodiment, a bandwidth of at least one of sub-bands of two ends of the N sub-bands is less than a bandwidth of a middle sub-band among the N sub-bands. For example, as shown in FIG. 7, the bandwidths of the two middle sub-bands (sub-band 2 and sub-band 3) among the 4 sub-bands are equal, and the bandwidths of sub-bands of the two ends (or edge sub-bands), that is, sub-band 1 and sub-band 4, are less than the bandwidths of the two middle sub-bands (sub-band 2 and sub-band 3).

It should be noted that, in the aforementioned embodiments, the N sub-bands include a downlink sub-band, used to fixedly transmit downlink data, so that the user equipment may acquire the information of the base station on the downlink sub-band to facilitate access to the base station and facilitate switching of the user equipment between cells. At least N-2 sub-bands among the N-1 sub-bands except the downlink sub-band are dynamic sub-bands that may be flexibly switched to facilitate the allocation of frequency domain resources during uplink data transmission process and downlink data transmission process and improve the utilization of frequency domain resources. In addition, in the data transmission method provided in the embodiments of the present disclosure, the uplink data and downlink data may be transmitted simultaneously on different sub-bands, effectively reducing latency of the data transmission.

The data transmission process shown in FIG. 3 above is explained below in combination with the embodiments and drawings of the specification, with detailed descriptions provided in the Embodiment 4 as follows.

### Embodiment 4

Taking FIG. 8 as an example, FIG. 8 is a schematic diagram of a process of a data transmission according to some embodiments. In this embodiment, as shown in FIG. 8, the frequency domain bandwidth is divided into N sub-bands, and the N sub-bands are respectively numbered as sub-band 1, sub-band 2, ..., sub-band N in an order from top to bottom.

The N sub-bands include M sub-bands for transmitting downlink data, and the M sub-bands include a downlink sub-band and M-1 dynamic sub-bands. Exemplarily, in FIG. 8, sub-bands except the sub-band 2 and sub-band 3 are used to transmit the downlink data.

Furthermore, an oversampled inverse Fourier transform is performed on the downlink data of each sub-band among sub-band 1, sub-band 4 to sub-band N respectively, to obtain M groups of first data sequences. In addition, since the sub-band 2 and sub-band 3 are used to transmit the uplink data, an all-zero sequence is added to the sub-band 2 and sub-band 3 respectively, to obtain N-M groups (2 groups) of second data sequences, and a length of the second data sequence is consistent with a length of the first data sequence. Then, according to an arrangement order of the sub-bands, the oversampled inverse Fourier transform is performed on the N groups of data sequences (including M groups of first data sequences and 2 groups of second data sequences), to obtain a group of time domain transmission data sequences, which are transmitted on the frequency domain bandwidth.

It should be noted that, the inverse Fourier transform is performed on each sub-band data respectively, and then the inverse Fourier transform is jointly performed on the obtained data sequence, so that the switching of the dynamic sub-band function will not affect the processing process of the downlink data during the data processing process, thereby ensuring the implementation of the dynamic sub-band scheme.

The data transmission process shown in FIG. 4 above is explained below in combination with the embodiments and drawings of the specification, with detailed descriptions provided in the Embodiment 5 and Embodiment 6 as follows.

### Embodiment 5

The frequency domain bandwidth is divided into N sub-bands, one of the N sub-bands is configured as a downlink sub-band (or referred to as a fixed downlink sub-band); N-1 sub-bands of the N sub-bands and except the downlink sub-band are configured as dynamic sub-bands. In a case where there are a plurality of dynamic sub-bands, the subcarrier spacings of at least two of the plurality of dynamic sub-bands are different.

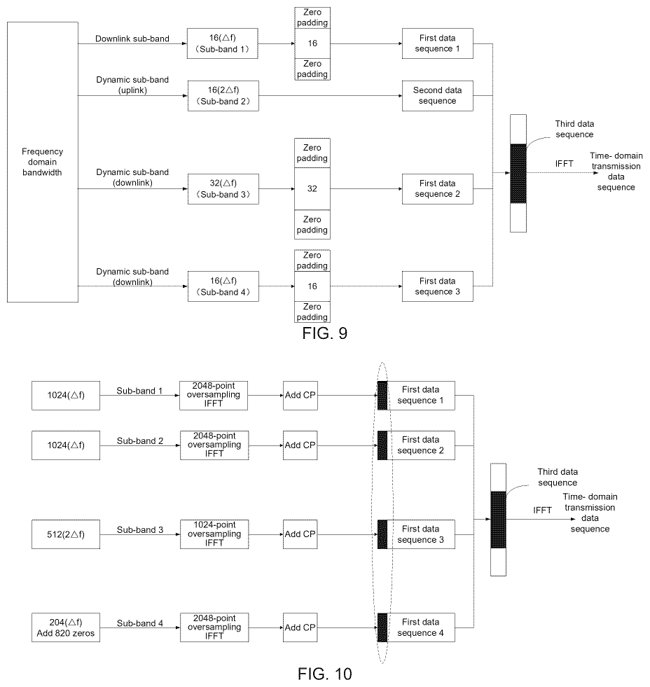

Taking FIG. 9 as an example, FIG. 9 is a schematic diagram of a process of another data transmission according to some embodiments. In this embodiment, as shown in FIG. 9, the frequency domain bandwidth is divided into 4 sub-bands, and the 4 sub-bands are respectively numbered as sub-band 1, sub-band 2, sub-band 3, and sub-band 4 in an order from top to bottom. The sub-band 1 is a downlink sub-band, the sub-band 2 is a dynamic sub-band for transmitting the uplink data, and the sub-band 3 and sub-band 4 are dynamic sub-bands for transmitting the downlink data.

In this embodiment, in a case where there are a plurality of dynamic sub-bands, the subcarrier spacings of at least two of the plurality of dynamic sub-bands are different.

For example, as shown in FIG. 9, the downlink sub-band 1 contains 16 subcarriers, and the subcarrier spacing is Δf. The dynamic uplink sub-band 2 contains 16 subcarriers, and the subcarrier spacing is 2Δf. The dynamic downlink sub-band 3 contains 32 subcarriers, and the subcarrier spacing is Δf. The dynamic downlink sub-band 4 contains 16 subcarriers, and the subcarrier spacing is Δf. That is, the subcarrier spacing of the dynamic uplink sub-band 2 is different from that of other dynamic sub-bands.

Therefore, in this embodiment, there are 3 sub-bands for transmitting the downlink data among the 4 sub-bands, including a downlink sub-band (sub-band 1) and two dynamic downlink sub-bands (sub-band 3 and sub-band 4).

First, since a number of subcarriers of downlink sub-band 1 is 16, a length of the downlink data is 16. After a zero padding operation is performed on the downlink data, a 2-times oversampled inverse Fourier transform is performed, to obtain a first data sequence 1 with a length of 32. Since a number of subcarriers of downlink sub-band 3 is 32, a length of the downlink data is 32. After a zero padding operation is performed on the downlink data, a 2-times oversampled inverse Fourier transform is performed, to obtain a first data sequence 2 with a length of 64. Since a number of subcarriers of downlink sub-band 4 is 16, a length of the downlink data is 16. After a zero padding operation is performed on the downlink data, a 2-times oversampled inverse Fourier transform is performed, to obtain a first data sequence 3 with a length of 32. The dynamic uplink sub-band 2 transmits the uplink data, and then an all-zero sequence is added, to obtain a second data sequence, and the length of second data sequence is 64, the same as the first data sequence 2.

Furthermore, the 4 groups of data sequences (including 3 groups of first data sequences and a group of second data sequence) generated by the 4 sub-bands are arranged in sequence into a data matrix, and then the 4 groups of third data sequences are extracted by columns, and the oversampled and inverse Fourier transform is performed on the 4 groups of third data sequences in the order of the sub-bands to obtain a time-domain transmission data sequence. It should be noted that, in the process of arranging into the data matrix, since the length of the first data sequence 1 and the length of the first data sequence 3 are 32, these two groups of data sequences may be repeated to make the length 64, consistent with the first data sequence 2 and the second data sequence.

### Embodiment 6

Each data sequence among the M groups of first data sequences includes a cyclic prefix (CP).

Taking FIG. 10 as an example, FIG. 10 is a schematic diagram of a process of yet another data transmission according to some embodiments. In this embodiment, as shown in FIG. 10, the frequency domain bandwidth is divided into 4 sub-bands, and the 4 sub-bands are respectively numbered as sub-band 1, sub-band 2, sub-band 3, and sub-band 4 in an order from top to bottom. The sub-band 1 to sub-band 4 are all used to transmit the downlink data.

The sub-band 1 has 1024 subcarriers with a subcarrier spacing of Δf. Zero data is added to the downlink data of sub-band 1 to implement a 2-times oversampled inverse Fourier transform to generate a first data sequence 1. The sub-band 2 has 1024 subcarriers, and the subcarrier spacing is Δf. Zero data is added to the downlink data of sub-band 2 to implement a 2-times oversampled inverse Fourier transform to generate a first data sequence 2. The sub-band 3 has 512 subcarriers, and the subcarrier spacing is 2Δf. Zero data is added to the downlink data of sub-band 3 to implement a 2-times oversampled inverse Fourier transform to generate a first data sequence 3. The sub-band 4 has 204 subcarriers, and the subcarrier spacing is Δf. 820 zeros are added to the outside of the downlink data of sub-band 4, and then zero data is added to implement a 2-times oversampled inverse Fourier transform to generate a first data sequence 4.

Furthermore, after the CP is added to each first data sequence, each first data sequence that the CP is added is arranged into a data matrix in the order of sub-bands, and 4 groups of third data sequences are extracted from the data matrix by columns. Finally, the oversampled inverse Fourier transform is performed on the 4 groups of third data sequences in the order of sub-bands, to obtain the time-domain transmission data sequence.

The implementation steps of the above S2023b are explained below by way of examples in combination with the embodiments and drawings of the specification, with detailed descriptions provided in the Embodiment 7 and Embodiment 8 as follows.

### Embodiment 7

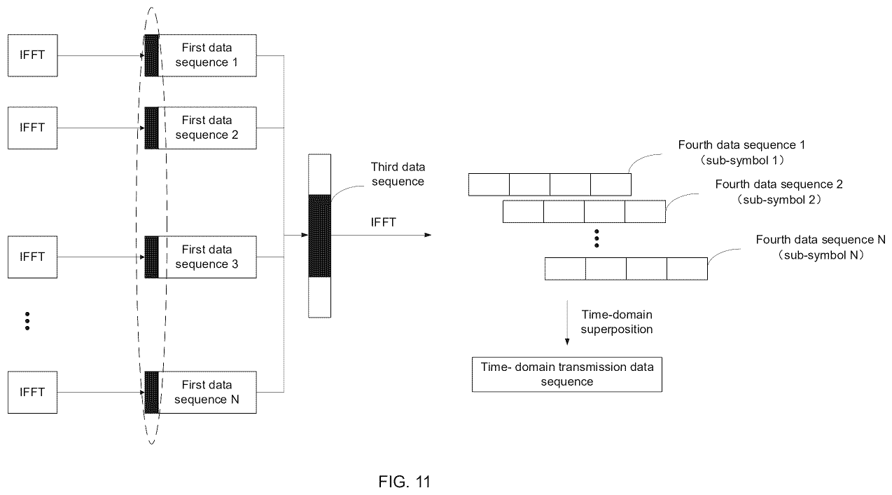

Taking FIG. 11 as an example, FIG. 11 is a schematic diagram of a process of yet another data transmission according to some embodiments. In this embodiment, as shown in FIG. 11, the frequency domain bandwidth is divided into N sub-bands, and the N sub-bands are respectively numbered as sub-band 1, sub-band 2, ..., sub-band N in an order from top to bottom. The sub-band 1 to sub-band N are all used to transmit the downlink data.

For the N groups of third data sequences obtained by performing the oversampled inverse Fourier transform on the downlink data of each sub-band, and the oversampled and inverse Fourier transform is further performed on each third data sequence among the N groups of third data sequences, to obtain N groups of fourth data sequences (or sub-symbols). The N groups of fourth data sequences are then windowed and superimposed in the time domain to obtain the time-domain transmission data sequence. For the windowing operation, reference may be made to the aforementioned description, which will not be repeated herein.

### Embodiment 8

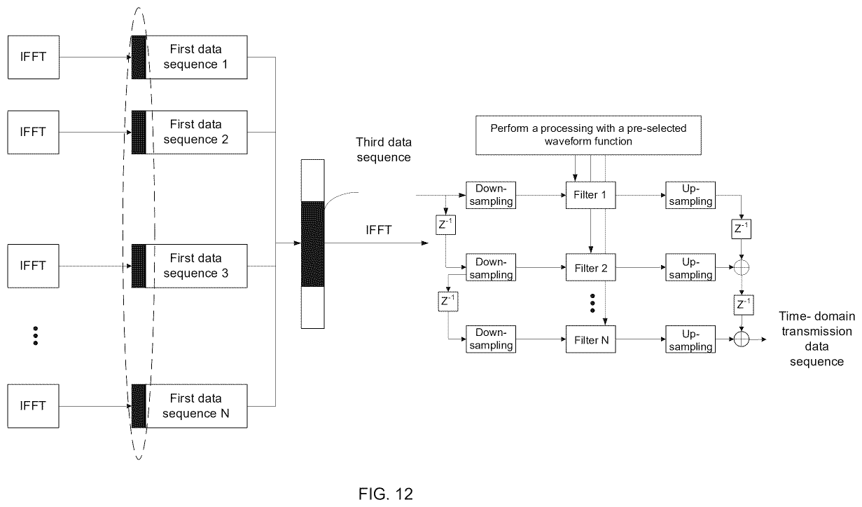

Taking FIG. 12 as an example, FIG. 12 is a schematic diagram of a process of yet another data transmission according to some embodiments. In this embodiment, as shown in FIG. 12, the frequency domain bandwidth is divided into N sub-bands, and the N sub-bands are respectively numbered as sub-band 1, sub-band 2, ..., sub-band N in an order from top to bottom. The sub-band 1 to sub-band N are all used to transmit the downlink data.

For N groups of third data sequences obtained by performing the oversampled inverse Fourier transform on the downlink data of each sub-band, each group of third data sequences among the N groups of third data sequences is processed by using a pre-selected waveform function. For example, for each group of the third data sequences, after delay (Z⁻¹ in the figure), downsampling, filtering, up-sampling and then addition.

The implementation steps of the above S2024 are explained below by way of examples in combination with the embodiments and drawings of the specification, with detailed descriptions provided in the Embodiment 9 as follows.

### Embodiment 9

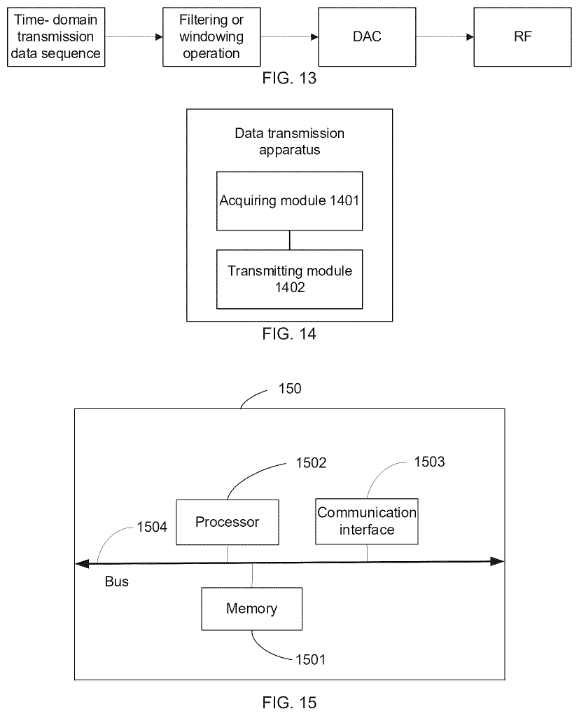

Taking FIG. 13 as an example, FIG. 13 is a schematic diagram of a process of yet another data transmission according to some embodiments. After performing filtering or windowing operation processing on a time-domain transmission data sequence, the time-domain transmission data sequence is converted into an analog signal through DAC processing, and then transmitted after RF processing. The windowing operation may include: equally grouping the time-domain transmission data sequence, to obtain N groups of data to be processed; performing periodic extension on each group of data to be processed and then point-multiplying a preset function, and then performing staggered superposition on the data of each group. The filtering includes single-phase filtering or multi-phase filtering, and the multi-phase filtering refers to that the time-domain transmission data sequence is grouped, to obtain N groups of data to be processed and filtering is performed on each group of data to be processed respectively. For details, reference may be made to some techniques, which will not be repeated herein.

The data transmission method provided in the embodiments of the present disclosure, in which the frequency domain bandwidth acquired includes a plurality of sub-bands, and the plurality of sub-bands include a downlink sub-band and a dynamic sub-band. The dynamic sub-band may be configured to transmit downlink data or uplink data based on actual needs. Therefore, when the data transmission is performed on the plurality of sub-bands, transmission resources for uplink data and downlink data may be flexibly allocated on the dynamic sub-band, thereby improving the utilization of frequency domain resources. In addition, the user equipment may acquire the signal of the base station on the downlink sub-band, so as to access the base station, which facilitates the switching of the user equipment between cells. Further, in the data transmission method provided in the embodiments of the present disclosure, the uplink data and downlink data may be transmitted simultaneously on different sub-bands, effectively reducing latency of the data transmission.

Further, the inverse Fourier transform is performed on each sub-band data respectively, and then the inverse Fourier transform is jointly performed on the obtained data sequence, so that the switching of the dynamic sub-band function will not affect the processing process of the downlink data during the data processing process, thereby ensuring the implementation of the dynamic sub-band scheme.

It can be understood that, in order to implement the above functions, the data transmission apparatus (may be the above base station) contains corresponding hardware structures and/or software modules for performing various functions. Those skilled in the art should easily realize that the present disclosure can be implemented in the form of hardware or a combination of hardware and computer software, in combination with the algorithm steps of various examples described in the embodiments of the present disclosure. Whether a certain function is performed by hardware or by computer software driving hardware, depends on a specific application and a design constraint condition of the technical solution. Professional technicians may use different methods to implement the described functions for each specific application, but such implementation should not be considered beyond the scope of the present disclosure.

In the embodiments of the present disclosure, the data transmission apparatus may be divided into functional modules according to the above-mentioned method embodiments, and for example, each functional module may be divided corresponding to each function, or two or more functions may also be integrated into one functional module. The above-mentioned integrated module may be implemented in the form of hardware or may also be implemented in the form of software. It should be noted that the division of the modules in embodiments of the present disclosure is schematic, which is only a logical functional division, and there may be other divisions for in actual implementations. The example in which each functional module may be divided corresponding to each function is taken for explanation below.

FIG. 14 is a structural schematic diagram of a data transmission apparatus according to some embodiments. The data transmission apparatus may perform the data transmission method provided by the above method embodiments. As shown in FIG. 14, the data transmission apparatus includes: an acquiring module 1401 and a transmitting module 1402.

The acquiring module 1401 is configured to configure a frequency domain bandwidth; the frequency domain bandwidth is divided into a plurality of sub-bands, and the plurality of sub-bands include a downlink sub-band and a dynamic sub-band; the dynamic sub-band is used to transmit downlink data or uplink data.

The transmitting module 1402 is configured to transmit the downlink data or the uplink data on the plurality of sub-bands included in the frequency domain bandwidth.

In some embodiments, the frequency domain bandwidth is divided into N sub-bands, one of the N sub-bands is configured as a downlink sub-band; there are at least N-2 dynamic sub-bands among the N-1 sub-bands of the N sub-bands and except the downlink sub-band, and N is an integer greater than or equal to 2.

In some embodiments, the dynamic sub-band is configured to transmit the uplink data or downlink data based on control information.

In some embodiments, the control information is transmitted through the downlink sub-band.

In some embodiments, the control information is carried in a radio resource control (RRC) signaling or downlink control information (DCI).

In some embodiments, the N-1 sub-bands include an uplink sub-band and N-2 dynamic sub-bands; or, the N-1 sub-bands include N-1 dynamic sub-bands; or, the N-1 sub-bands include a downlink sub-band and N-2 dynamic sub-bands.

In some embodiments, N is an odd number, and the downlink sub-band is a middle sub-band among the N sub-bands; N is an even number, and the downlink sub-band is one of the two middle sub-bands among the N sub-bands.

In some embodiments, subcarrier spacings of the N sub-bands are the same, or, in a case where there are a plurality of dynamic sub-bands, the subcarrier spacings of at least two of the plurality of dynamic sub-bands are different.

In some embodiments, a bandwidth of at least one of sub-bands of the two ends of the N sub-bands is less than a bandwidth of a middle sub-band of the N sub-bands.

In some embodiments, a number of subcarriers in the N-2 middle sub-bands among the N sub-bands is 2 to a power of i, and i is a positive integer.

In some embodiments, the transmitting module 1402 is configured to, in a case where there are M sub-bands for transmitting the downlink data among the N sub-bands, perform an inverse Fourier transform on the downlink data on each sub-band among the M sub-bands, to obtain M groups of first data sequences; M is a positive integer; add an all-zero data sequence to other sub-bands except the M sub-bands among the N sub-bands, to obtain N-M groups of second data sequences; a length of the second data sequence is identical to a length of the first data sequence; perform the inverse Fourier transform on the M groups of first data sequences and the N-M groups of second data sequences, to obtain a time-domain transmission data sequence; and transmit the time-domain transmission data sequence.

In some embodiments, the M sub-bands include a downlink sub-band and a dynamic sub-band for transmitting the downlink data.

In some embodiments, the inverse Fourier transform performed on the downlink data on each sub-band among the M sub-bands is an oversampled inverse Fourier transform.

In some embodiments, positions of zero-frequency positions in frequency domain where the oversampled inverse Fourier transform is performed on the downlink data on respective sub-band among the M sub-bands are different.

In some embodiments, a zero-frequency position where the oversampled inverse Fourier transform is performed on downlink data on a sub-band among the M sub-bands is within a frequency range of a bandwidth of a sub-band.

In some embodiments, a zero-frequency position where the oversampled inverse Fourier transform is performed on downlink data on a sub-band among the M sub-bands is within a frequency range of a sub-carrier of the sub-band.

In some embodiments, the transmitting module 1402 is configured to acquire N groups of third data sequences from a data matrix by columns; where the data matrix includes: the M groups of first data sequences and the N-M groups of second data sequences arranged by rows based on an order of the N sub-bands; and perform the oversampled inverse Fourier transform on the N groups of third data sequences, to obtain the time-domain transmission data sequence.

In some embodiments, each data sequence of the M groups of first data sequences includes a cyclic prefix (CP).

In some embodiments, the transmitting module 1402 is configured to perform the oversampled inverse Fourier transform on the N groups of third data sequences, to obtain N groups of fourth data sequences; and perform a windowing operation on the N groups of fourth data sequences, to obtain the time-domain transmission data sequence.

In some embodiments, the transmitting module 1402 is configured to perform the oversampled inverse Fourier transform on the N groups of third data sequences, to obtain N groups of fourth data sequences; and perform a preset processing on the N groups of fourth data sequences respectively and perform an adding, to obtain the time-domain transmission data sequence; where the preset processing includes: downsampling, filtering and upsampling.

In some embodiments, the transmitting module 1402 is configured to perform a filtering operation or a windowing operation on the time-domain transmission data sequence, and then perform a digital-to-analog converter (DAC) processing and a radio frequency (RF) processing before transmission.

In some embodiments, a number of points for the oversampled inverse Fourier transform performed on the downlink data on each sub-band is less than a total number of subcarriers of the plurality of sub-bands; and a 2-times oversampled inverse Fourier transform is performed on N-2 middle sub-bands among the N sub-bands.

In some embodiments, a number of points for the oversampled inverse Fourier transform performed on the N groups of third data sequences is greater than a number of the plurality of sub-bands.

In a case where the functions of the above integrated modules are implemented in the form of hardware, the embodiments of the present disclosure provide another structure of the communication apparatus involved in the above embodiments. As shown in FIG. 15, the communication apparatus 150 includes a processor 1502 and a bus 1504. In some embodiments, the communication apparatus may further include a memory 1501; in some embodiments, the communication apparatus may further include a communication interface 1503.

The processor 1502 may implement or perform various exemplary logical blocks, modules and circuits described in conjunction with the embodiments of the present disclosure. The processor 1502 may be a central processing unit, a general-purpose processor, a digital signal processor, an application specific integrated circuit, a field programmable gate array or any other programmable logic device, a transistor logic device, a hardware component, or any combination thereof. The processor 1502 may implement or perform various exemplary logical blocks, modules and circuits described in conjunction with the embodiments of the present disclosure. The processor 1502 may also be a combination that implements computing functions, for example, including a combination of one or more microprocessors, a combination of a digital signal processor (DSP) and a microprocessor, or the like.

The communication interface 1503 is configured to connect with other devices via a communication network. The communication network may be the Ethernet, wireless access network, wireless local area networks (Wireless Local Area Network, WLAN), etc.

The memory 1501 may be, but be not limited to, a read-only memory (ROM) or other types of static storage devices capable of storing static information and instructions, a random access memory (RAM) or other types of dynamic storage devices capable of storing information and instructions, or may also be an electrically erasable programmable read-only memory (EEPROM), a magnetic disk storage medium or other magnetic storage devices, or any other medium capable of being used to carry or store the desired program codes in the form of instructions or data structures and capable of being accessed by a computer.

As an implementation, the memory 1501 may exist independently of the processor 1502, and the memory 1501 may be connected to the processor 1502 via the bus 1504 and is used for storing instructions or program codes. The processor 1502, when calling and executing the instructions or program codes stored in the memory 1501, is capable of implementing the data transmission method provided in the embodiments of the present disclosure.

As another implementation, the memory 1501 may be integrated with the processor 1502.

The bus 1504 may be an extended industry standard architecture (EISA) bus or the like. Buses 1504 may be divided into address buses, data buses, control buses, and the like. For ease of representation, only one bold line is used for the representation in FIG. 15, but it does not mean that there is only one bus or one type of the bus.

Some embodiments of the present disclosure provide a computer readable storage medium (e.g., a non-transitory computer readable storage medium), and the computer readable storage medium has stored computer program instructions therein, and the computer program instructions, when executed on a computer, cause the computer to perform the data transmission method as described in any embodiment of the above-mentioned embodiments.

Exemplarily, the above-mentioned computer readable storage medium may include, but be not limited to, a magnetic storage device (e.g., a hard disk, a floppy disk or a magnetic tape, etc.), an optical disk (e.g., a Compact Disk (CD) or a Digital Versatile Disk (DVD), etc.), a smart card and a flash memory device (e.g., an Erasable Programmable Read-Only Memory (EPROM), a card, a stick or a key driver, etc.). The various computer readable storage medium described in the present disclosure may represent one or more devices and/or other machine-readable storage media for storing information. The term “machine readable storage medium” may include, but be not limited to, a radio channel and various other media capable of storing, containing, and/or carrying instructions and/or data.

The embodiments of the present disclosure provide a computer program product containing instructions, and the computer program product, when running on a computer, causes the computer to perform the data transmission method as described in any embodiment of the above-mentioned embodiments.

The above descriptions are only specific implementations of the present disclosure, but the protection scope of the present disclosure is not limited thereto, any variations or replacements within the technical scope disclosed in the present disclosure shall be included in the protection scope of the present disclosure. Therefore, the protection scope of the present disclosure shall be determined by the protection scope of the claims.

What is claimed is:

1. A data transmission method, comprising:
configuring a frequency domain bandwidth; wherein the frequency domain bandwidth is divided into a plurality of sub-bands, the plurality of sub-bands comprise a downlink sub-band and a dynamic sub-band; the dynamic sub-band is used for transmitting downlink data or uplink data; and
transmitting the downlink data or the uplink data on the plurality of sub-bands comprised in the frequency domain bandwidth.

2. The method according to claim 1, wherein the frequency domain bandwidth is divided into N sub-bands, one of the N sub-bands is configured as a downlink sub-band; there are at least N-2 dynamic sub-bands among the N-1 sub-bands of the N sub-bands and except the downlink sub-band, and N is an integer greater than or equal to 2.

3. The method according to claim 2, wherein the dynamic sub-band is configured to transmit the uplink data or the downlink data based on control information.

4. The method according to claim 3, wherein the control information is transmitted through the downlink sub-band.

5. The method according to claim 3, wherein the control information is carried in a radio resource control (RRC) signaling or downlink control information (DCI).

6. The method according to claim 2, wherein
the N-1 sub-bands comprise an uplink sub-band and N-2 dynamic sub-bands; or
the N-1 sub-bands comprise N-1 dynamic sub-bands; or
the N-1 sub-bands comprise a downlink sub-band and N-2 dynamic sub-bands.

7. The method according to claim 2, wherein
N is an odd number, and the downlink sub-band is a middle sub-band among the N sub-bands; or
N is an even number, and the downlink sub-band is one of two middle sub-bands among the N sub-bands.

8. The method according to claim 2, wherein subcarrier spacings of the N sub-bands are the same, or, in response to that there are a plurality of dynamic sub-bands, subcarrier spacings of at least two dynamic sub-bands among the plurality of dynamic sub-bands are different; or bandwidths of N-2 middle sub-bands among the N sub-bands are equal, and a bandwidth of at least one of sub-bands of two ends of the N sub-bands is not equal to a bandwidth of a middle sub-band of the N sub-bands; or a number of subcarriers of N-2 middle sub-bands among the N sub-bands is 2 to a power of i, wherein i is a positive integer.

9-10. (canceled)

11. The method according to claim 2, wherein transmitting the downlink data or the uplink data on the plurality of sub-bands comprised in the frequency domain bandwidth comprises:
in response to that there are M sub-bands for transmitting the downlink data among the N sub-bands, performing an inverse Fourier transform on downlink data on each sub-band among the M sub-bands, to obtain M groups of first data sequences, wherein M is a positive integer;
adding an all-zero data sequence to other sub-bands except the M sub-bands among the N sub-bands, to obtain N-M groups of second data sequences; wherein a length of the second data sequence is identical to a length of the first data sequence;
performing the inverse Fourier transform on the M groups of first data sequences and the N-M groups of second data sequences, to obtain a time-domain transmission data sequence; and
transmitting the time-domain transmission data sequence.

12. The method according to claim 11, wherein
the M sub-bands comprise the downlink sub-band and a dynamic sub-band for transmitting the downlink data; or
the inverse Fourier transform performed on the downlink data on each sub-band among the M sub-bands is an oversampled inverse Fourier transform.

13. (canceled)

14. The method according to claim 12, wherein positions of zero-frequency positions in frequency domain where the oversampled inverse Fourier transform is performed on the downlink data on the respective sub-bands among the M sub-bands are different.

15. The method according to claim 14, wherein a zero-frequency position where the oversampled inverse Fourier transform is performed on downlink data on a sub-band among the M sub-bands is within a frequency range of a bandwidth of the sub-band.

16. The method according to claim 15, wherein a zero-frequency position where the oversampled inverse Fourier transform is performed on downlink data on a sub-band among the M sub-bands is within a frequency range of a subcarrier of the sub-band.

17. The method according to claim 16, wherein performing the inverse Fourier transform on the M groups of first data sequences and the N-M groups of second data sequences, to obtain the time-domain transmission data sequence comprises:
acquiring N groups of third data sequences from a data matrix by columns; wherein the data matrix comprises: the M groups of first data sequences and the N-M groups of second data sequences arranged by rows based on an order of the N sub-bands; and
performing the oversampled inverse Fourier transform on the N groups of third data sequences, to obtain the time-domain transmission data sequence.

18. The method according to claim 17, wherein each data sequence of the M groups of first data sequences comprises a cyclic prefix (CP).

19. The method according to claim 18, wherein performing the oversampled inverse Fourier transform on the N groups of third data sequences, to obtain the time-domain transmission data sequence comprises:
performing the oversampled inverse Fourier transform on the N groups of third data sequences, to obtain N groups of fourth data sequences; and
performing a windowing operation on the N groups of fourth data sequences, to obtain the time-domain transmission data sequence; or
performing the oversampled inverse Fourier transform on the N groups of third data sequences, to obtain the time-domain transmission data sequence comprises: performing the oversampled inverse Fourier transform on the N groups of third data sequences, to obtain N groups of fourth data sequences; and performing a preset processing on the N groups of fourth data sequences respectively and performing an adding, to obtain the time-domain transmission data sequence; wherein the preset processing comprises: downsampling, filtering and upsampling.

20. (canceled)

21. The method according to claim 11, wherein transmitting the time-domain transmission data sequence comprises:
performing a filtering operation or a windowing operation on the time-domain transmission data sequence and performing a digital-to-analog converter (DAC) processing and a radio frequency (RF) processing before transmission.

22. The method according to claim 21, wherein a number of points for an oversampled inverse Fourier transform performed on downlink data on each sub-band is less than a total number of subcarriers of the plurality of sub-bands;
wherein a 2-times oversampled inverse Fourier transform is performed on N-2 middle sub-bands among the N sub-bands; or
a number of points for an oversampled inverse Fourier transform performed on the N groups of third data sequences is greater than a number of the plurality of sub-bands.

23. (canceled)

24. A communication apparatus, comprising: a processor and a memory for storing instructions executable for the processor;
wherein the processor is configured to execute the instructions, so that the communication apparatus performs operations of:
configuring a frequency domain bandwidth; wherein the frequency domain bandwidth is divided into a plurality of sub-bands, the plurality of sub-bands comprise a downlink sub-band and a dynamic sub-band; the dynamic sub-band is used for transmitting downlink data or uplink data; and
transmitting the downlink data or the uplink data on the plurality of sub-bands comprised in the frequency domain bandwidth.

25. A non-transitory computer readable storage medium, wherein the computer readable storage medium has stored computer instructions thereon, and the computer instructions, when executed on a communication apparatus, cause the communication apparatus to perform operations of:
configuring a frequency domain bandwidth; wherein the frequency domain bandwidth is divided into a plurality of sub-bands, the plurality of sub-bands comprise a downlink sub-band and a dynamic sub-band; the dynamic sub-band is used for transmitting downlink data or uplink data; and
transmitting the downlink data or the uplink data on the plurality of sub-bands comprised in the frequency domain bandwidth.
